(19) United States
(12) Patent Application Publication
(10) Pub. No.: US 2008/0151709 A1
(43) Pub. Date: Jun. 26, 2008

(54) SEEKING METHOD FOR OPTICAL DISK DRIVE

(75) Inventor: Chang-Chih Wu, Shenzhen (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/613,200

(22) Filed: Dec. 20, 2006

(51) Int. Cl. G11B 5/09

(52) U.S. Cl. 369/44.28

(57) ABSTRACT

An optical disk drive is used for recording data to and/or reproducing data from an optical disk. The optical disk drive includes a pickup head, a stepping motor, an ASP, and a DSP. The stepping motor is used for moving a pickup head to seek a target track of the optical disk from an initial track. The ASP is used for converting an analog electronic signal from the pickup head to a digital electronic signal. The DSP is used for obtaining a current position of the pickup head by analyzing the digital electronic signal, and for calculating a current track count between the current track area and the target track area and modifying a current distance per step of the stepping motor with an actual distance per step calculated based on the current track count. A seeking method is also disclosed.

### BACKGROUND OF THE INVENTION

1. Field of the Invention

The present invention generally relates to servo methods for optical disk drives, and more particularly to a seeking method for seeking a target track area of an optical disk and an optical disk drive adopting the seeking method.

2. Description of Related Art

Generally, an optical disk includes a plurality of concentric tracks or a continuous spiral track on a recording surface thereof. Data recorded on the optical disk are reproduced by first projecting light beams onto the tracks, and then detecting reflected light beams from the tracks to obtain an analog signal. An optical disk drive is such a device to reproduce data from the optical disk. The optical disk drive includes a pickup head emitting the light beams and converting the reflected light beams to an analog electronic signal, an analog signal processor (ASP) converting the analog electronic signal to a digital electronic signal, and a digital signal processor obtaining information including a position of the pickup head and a track address of a corresponding track on the disk by decoding the digital electronic signal.

In an optical disk drive, two kinds of servo operations, seek operation and track operation, are sequentially performed. The seek operation is a movement of a projecting light beam from a current track area to a target track area, and the track operation is a movement in the target track area to precisely reach a target track. In other words, the seek operation is a coarse adjustment reaching the target track area, and the tracking operation is a delicate adjustment after the seeking operation to precisely reach the target track so as to obtain desired information on the target track.

Referring to FIG. 4, a typical optical disk drive 400 includes a pickup head 450 for projecting light beams onto an optical disk 530 and a stepping motor 440 for moving the pickup head 450. The stepping motor 440 includes a rotatable worm 442 in mesh with the pickup head 450 to move together along a rotating axis of the worm 442.

Unlike direct current (DC) motors, the stepping motor (also called a step motor or a stepper motor) 440 does not produce a continuous motion from a continuous input voltage. One pulse into the stepping motor 440 causes a rotor (usually a worm) thereof to move one precise angle (technically called step angle). This movement is repeated with each input pulse. For a given application, the step angle of the stepping motor 440 and a thread pitch of the worm 442 are adjustable. For an optical disk drive, the step angle and the screw interval determine distance per step N of the optical disk drive, which indicates the number of the tracks that the pickup head jumps over in one seeking step.

Before a seek operation, the pickup head 450 is at an initial position 443 corresponding to an initial track area 533 of the optical disk 530. During the seek operation, the pickup head 450 is moved from the initial position 443 toward a target position 445 corresponding to a target track area 535 on the optical disk 530. In practice, the pickup head 450 directly reaches an actual track 534 other than the target track 535, because different optical disks or even different track areas on one optical disk are not exactly the same, and parameters of the optical disk drive are accordingly not exact for these different optical disks or different track areas. A further seek operation or a plurality of track seek operations need be done to reach the target track area 535. Whenever the pickup head 450 is moved to a new target track area, it cannot directly reach the new target track area expectedly and a further seek operation should be done.

As described above, before the pickup head 450 reaches the target track area 535, the seek operation may be performed many times. Thus, the seek operation is time-consuming.

Therefore, a track seeking method for an optical disk drive and an optical disk drive utilizing the track seeking method are needed in the industry to address the aforementioned deficiencies and inadequacies.

### SUMMARY OF THE INVENTION

An optical disk drive is used for recording data to and/or reproducing data from an optical disk. The optical disk drive includes a pickup head, a stepping motor, an ASP, and a DSP. The stepping motor is used for moving a pickup head to seek a target track of the optical disk from an initial track. The ASP is used for converting an analog electronic signal from the pickup head to a digital electronic signal. The DSP is used for obtaining a current position of the pickup head by analyzing the digital electronic signal, and for calculating a current track count between the current track area and the target track area and modifying a current distance per step of the stepping motor with an actual distance per step calculated based on the current track count. A seeking method is also disclosed.

Other systems, methods, features, and advantages of the present optical disk drive and seeking method will be or become apparent to one with skill in the art upon examination of the following drawings and detailed description. It is intended that all such additional systems, methods, features, and advantages be included within this description, be within the scope of the present device, and be protected by the accompanying claims.

### BRIEF DESCRIPTION OF THE DRAWINGS

Many aspects of the present optical disk drive and the present seeking method can be better understood with reference to the following drawings. The components in the drawings are not necessarily to scale, emphasis instead being positioned upon clearly illustrating the principles of the present device. Moreover, in the drawings, like reference numerals designate corresponding parts throughout the several views.

FIG. 1 is a block diagram showing an optical disk and an optical disk drive in accordance with an exemplary embodiment, the optical disk drive including a DSP;

FIG. 2 is a block diagram showing the DSP of the FIG. 1;

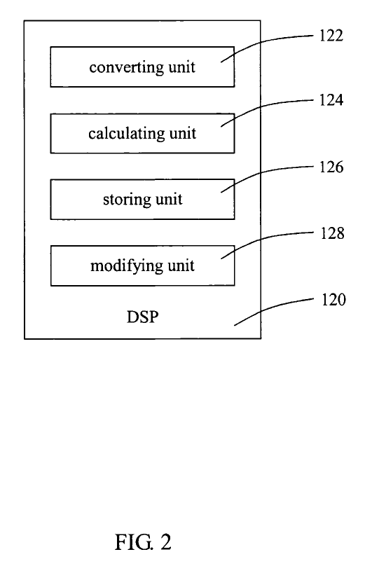

FIG. 3 is a process flow diagram illustrating a seeking method in accordance with an exemplary embodiment; and

FIG. 4 is a schematic diagram showing movements of a pickup head of a conventional optical disk.

### DETAILED DESCRIPTION OF THE INVENTION

Reference will now be made to the drawings to describe preferred embodiments of a present optical disk drive and a preferred embodiment of the present seeking method.

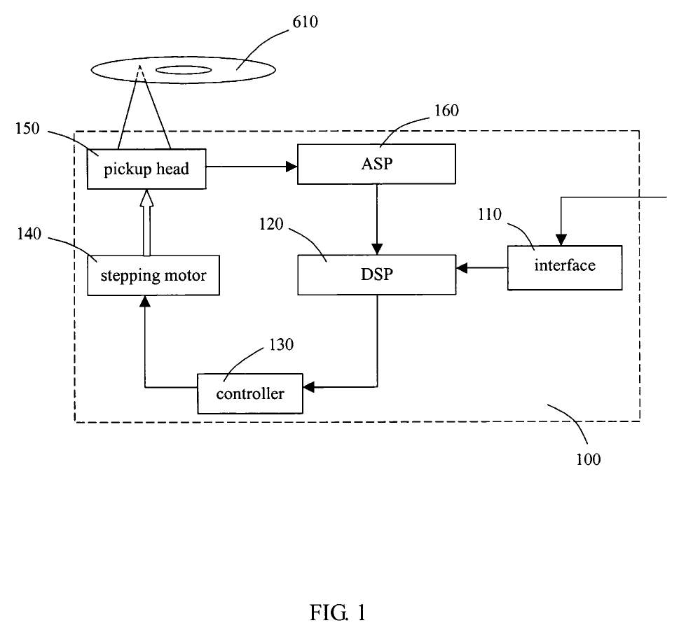

Referring to FIG. 1, an optical disk drive 100 in accordance with an exemplary embodiment is used for recording data to and/or reproducing data from an optical disk 610. The optical disk drive 100 includes an interface 110, a digital signal processor (DSP) 120, a controller 130, a stepping motor 140, a pickup head 150, and an analog signal processor (ASP) 160. The interface 110 is connected to the DSP 120. The pickup head 150, the ASP 160, the DSP 120, the controller 130, and the stepping motor 140 are electronically connected sequentially. The pickup head 150 is mechanically coupled to the stepping motor 140.

The interface 110 is used for receiving an external seeking command, including information of a target track area on the optical disk 610. The DSP 120 stores a distance per step N therein, and calculates a total step count N2 of steps that the stepping motor 140 needs to move the pickup head 450 to a target track area, and modifying a current distance per step N1 of the stepping motor 140. The controller 130 receives the current distance per step N1 from the DSP 120 and generates a control signal to be sent to the stepping motor 140. The stepping motor 140 is used for generating a driving force to move the pickup head 150 from an initial position to a target position. The pickup head 150 is used for emitting a light beam to the optical disk 610, receiving a reflected light beam from the optical disk 610, and converting the reflected light to an analog electronic signal. The ASP 160 receives the analog electronic signal from the pickup head 150 and processes the analog electronic signal to be sent to the DSP 120. The DSP 120 converts the analog electronic signal to a digital electronic signal, and analyzes the digital electronic signal to obtain information of a current track area and a current position of the pickup head 150 corresponding to the current track area.

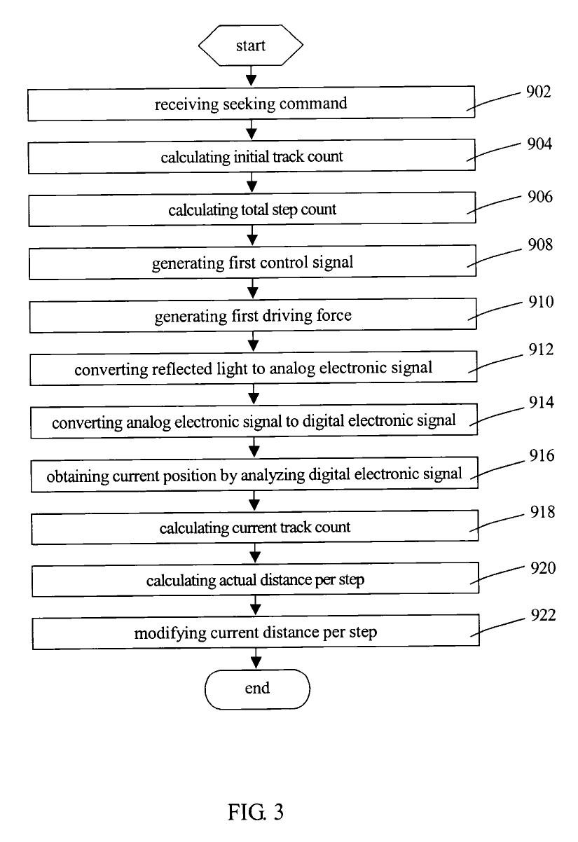

Referring also to FIG. 3, the DSP 120 includes a converting unit 122, a calculating unit 124, a storing unit 126, and a modifying unit 128. The converting unit 122 converts the analog electronic signal from the ASP 160 into a digital electronic signal. The calculating unit 124 is used for analyzing the digital electronic signal to obtain information of the current track area and the current position. The calculating unit 124 has a function of calculating an initial track count N4 between an initial track area and the target track area, and the total step count N2 by dividing the initial track count N4 by the current distance per step N1. Furthermore, the calculating unit 124 has another function of calculating a current track count N5 between the current track area and the target track area. The storing unit 126 is used for storing the current distance per step N1. The modifying unit 128 is used for calculating an actual distance per step N3 based on the current track count N5, and modifying the current distance per step N1 with the actual distance per step N3. After the modification, the current distance per step Ni will be used in a next seek operation.

Many calculating methods can be used by the modifying unit 128 to calculate the actual distance per step N3, and many corresponding modifying methods also can be used. For example, the actual distance per step N3 is obtained by dividing the current track count N5 by the total step count N2, which is indicated in the following equation (1).

N3=N5/N2 (1)

The actual distance per step N3 is added to the current distance per step N1, or subtracted from the current distance per step N1. For a second example, the actual distance per step N3 is also be obtained by dividing a sum of the initial track count N4 and the current track count N5 by the total step count N2, which is indicated in the following equation (2).

N3=(N4+N5)/N2 (2)

The actual distance per step N3 is used to replace the current distance per step N1. For a third example, the actual distance per step N3 is also obtained by dividing a difference between the initial track count N4 and the current track count N5 by the total step count N2, which is indicated in the following equation (3).

N3=N4−N5|/N2 (3)

### The actual distance per step N3 is added to the current distance per step N1, or subtracted from the current distance per step N1.

In this embodiment, a distance per step is modified, which leads to a more accurate movement of the pickup head 150. Therefore, in practice, the optical disk drive 100 can adjust parameters by itself, resulting in a more rapid seek operation.

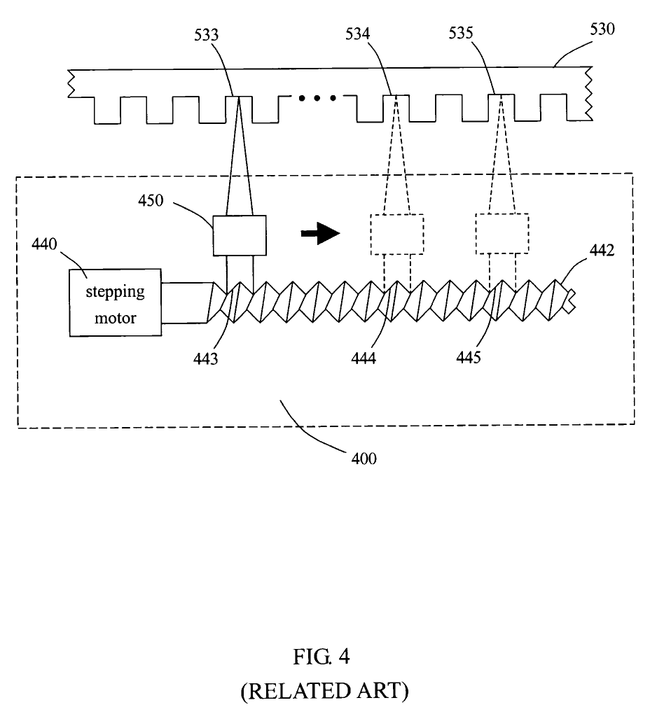

Referring to FIG. 4, a seeking method in accordance with an exemplary embodiment includes following steps.

The interface 110 receives a seeking command including information of a target track (step 902).

The calculating unit 124 calculates an initial track count N4 of tracks between an initial track and the target track (step 904).

The calculating unit 124 calculates a total step count N2 by dividing the initial track count N4 by a current distance per step N1 stored in the storing unit 126 (step 906).

The controller 130 receives information including the total step count N2 and the current distance per step N1, and generates a first control signal to be sent to the stepping motor 140 (step 908).

The stepping motor 140 generates a first driving force to move the pickup head 150 based on the first control signal (step 910).

The pickup head 150 receives the reflected light, and converts the reflected light to an analog electronic signal (step 912).

The converting unit 122 converts the analog electronic signal to a digital electronic signal (step 914).

The calculating unit 124 obtains information of the current operation of the pickup head 150 and the current track area by analyzing the digital electronic signal (step 916)

The calculating unit 124 calculates a current track count N5 of tracks between the current track area and the target track area (step 918).

The modifying unit 128 calculates an actual distance per step N3 based on the current track count N5 (step 920).

The modifying unit 128 modifies the current distance per step N1 using the actual distance per step N3 to use the modified current distance per step N1 in a next seek operation (step 922).

As mentioned above, the current distance per step N1 of the distance per step is modified with the actual distance per step N3. Therefore, a more accurate movement of the pickup head 150 can be accomplished.

It should be emphasized that the above-described preferred embodiments, are merely possible examples of implementation of the principles of the invention, and are merely set forth for a clear understanding of the principles of the invention. Many variations and modifications may be made to the above-described embodiments of the invention without departing substantially from the spirit and principles of the invention. All such modifications and variations are intended to be included herein within the scope of this disclosure and the present invention and be protected by the following claims.

What is claimed is:

1. An optical disk drive for recording data to and/or reproducing data from an optical disk, the optical disk drive comprising:
a pickup head configured for emitting a light beam to the optical disk, receiving a reflected light from the optical disk, and converting the reflected light to an analog electronic signal;
a stepping motor configured for moving the pickup head to seek a target track area of the optical disk from an initial track area;
an analog signal processor configured for processing the analog electronic signal converted by the pickup head; and
a digital signal processor configured for converting the analog electronic signal processed by the analog signal processor into a digital electronic signal, obtaining a current track area of the pickup head by analyzing the digital electronic signal, and calculating a current track count between the current track area and the target track area and modifying a current distance per step of the stepping motor with an actual distance per step calculated based on the current track count.

2. The optical disk drive according to claim 1, wherein the digital signal processor comprises a converting unit for converting the analog electronic signal to a digital electronic signal.

3. The optical disk drive according to claim 2, wherein the digital signal processor comprises a calculating unit for analyzing the digital electronic signal, and calculating an initial track count between the initial track area and the target track area, and for calculating a total step count by dividing the initial track count by the current distance per step, and for calculating a current track count between the current track area and the target track area.

4. The optical disk drive according to claim 3, wherein the digital signal processor comprises a modifying unit for calculating an actual distance per step based on the current track count, and modifying the current distance per step with the actual distance per step.

5. The optical disk drive according to claim 4, wherein the digital signal processor comprises a storing unit for storing the current distance per step.

6. The optical disk drive according to claim 5, further comprising an interface for receiving an external seeking command including information of the target track area.

7. The optical disk drive according to claim 6, further comprising a controller for generating a control signal based on the current distance per step to be sent to the stepping motor.

8. A seeking method for seeking a target track area of an optical disk, the seeking method comprising steps of:
obtaining a current track area;
calculating an actual distance per step of a stepping motor based on the current track area and the target track area; and
modifying a current distance per step with the actual distance per step.

9. The seeking method according to claim 8, further comprising a step of receiving a seeking command including information of the target track area.

10. The seeking method according to claim 9, further comprising a step of calculating an initial track count between an initial track area and the target track area.

11. The seeking method according to claim 10, further comprising a step of calculating a total step count by dividing the initial track count by the current distance per step.

12. The seeking method according to claim 11, further comprising steps of:
generating a first control signal based on the total step count and the current distance per step; and
generating a first driving force based on the first control signal.

13. The seeking method according to claim 12, further comprising steps of:
converting reflected light to an analog electronic signal;
converting the analog electronic signal into a digital electronic signal; and
obtaining a current track area by analyzing the digital electronic signal.

14. The seeking method according to claim 13, further comprising steps of:
calculating a current track count between the current track area and the target track area; and
calculating the actual distance per step based on the current track count.
